(19) United States
(12) Patent Application Publication
(10) Pub. No.: US 2021/0115939 A1
(43) Pub. Date: Apr. 22, 2021

(54) IMPELLER FOR AMBIENT WATER EVAPORATORS, AND RELATED SYSTEM AND METHOD

(71) Applicant: Resource West, Inc., Grand Junction, CO (US)

(72) Inventors: William MacDonald, Grand Junction, CO (US); Robert Ballantyne, Clifton, CO (US)

(21) Appl. No.: 17/046,968

(22) PCT Filed: Apr. 12, 2019
(86) PCT No.: PCT/US2019/027384

§ 371 Date: Oct. 12, 2020

Related U.S. Application Data
(60) Provisional application No. 62/656,856, filed on Apr. 12, 2018.
(60) Provisional application No. 62/656,887, filed on Apr. 12, 2018.
(60) Provisional application No. 62/656,906, filed on Apr. 12, 2018.

(51) Int. Cl. F04D 29/38; F04D 25/08; F04D 13/06; F04D 29/34; F04D 29/54; F04D 29/60; F04D 29/70; B01D 1/00; B01D 1/20

(52) U.S. Cl. CPC F04D 29/384; F04D 25/08; F04D 13/066; F04D 29/34; F04D 29/54; F05B 2240/301; F04D 29/705; B01D 1/0005; B01D 1/0094; B01D 1/20; F04D 29/601

(57) ABSTRACT

An impeller design is provided for use in evaporating water from an ambient water body. The impeller includes a hub and a plurality of impeller blades. The blades have one or more profiles that correspond to certain profiles characterized by the National Advisory Committed for Aeronautics parameters known as NACA 4 parameters. One or more blade angles also may more specifically identify the blade profiles. The impeller blades also may be identified by a plurality of profiles on a given blade, preferably including a base profile and a tip profile. The impeller optionally but preferably is made of a fiberglass material. In preferred embodiments it constitutes an integrated unit, such as a unitary molded or cast unit. It may be coated by a suitable corrosion-resistant coating, for example, such as a clear coat or gel coat. Various features of the impeller hub also are disclosed. An impeller system also is disclosed. The system includes an impeller as described above and means for mitigating non-longitudinal flow in the air flow channel in which the impeller caused air movement. The means for mitigating non-longitudinal flow preferably includes a plurality of guide vanes disposed downstream of the impeller.

### CROSS-REFERENCES TO RELATED APPLICATIONS

This application claims priority and the benefit of earlier filing date to U.S. Provisional Application No. 62/656,856, No. 62/656,887, and No. 62/656,906, all of which were filed on Apr. 12, 2018. The entire contents of each of these patent applications are hereby expressly incorporated herein by reference in their entirety as if fully set forth herein, including without limitation the specification or disclosure, claims, abstract, and all drawings, figures and tables thereof.

### FIELD OF THE INVENTION

The present invention relates to impellers, impeller systems and related methods for use in evaporating water from an ambient water body, for example, such a pond, lake or the like. This includes artificial ambient water bodies, for example, as are commonly used in industrial applications such as oil and gas drilling operations, mining operations, waste water management, and the like.

### BACKGROUND OF THE INVENTION AND RELATED ART

There are many applications in which it is desirable or necessary to evaporate or dispose of water, often in substantial quantities, from an ambient water body such as a pond, lake, impoundment pond, flooded region, or the like. In a significant number of those applications, the water has some form of impurity that precludes simple disposition in another water body, such as a river, lake or stream. Impoundment ponds associated with oil and gas drilling operations are examples. These ponds often contain high levels of suspended solids, dissolved solids or ions, possibly various forms of hydrocarbons, and so on.

A commonly-used approach to disposing of the water in these water bodies involves physically transporting the water to a disposal site, such as an authorized injection well. Another approach that has been used involves evaporation. In this approach, the water is evaporated into the surrounding air so that the water itself evaporates but at least a portion of the impurities are left behind. Natural evaporation is of limited utility because the evaporation rate usually is unworkably slow. Evaporation devices have been employed that actively facilitate and speed up the evaporation process, for example, by spraying the water into the air, or by entraining the water as droplets in a forced air stream directed into the air. Evaporators that have been commercially available in recent years from the present assignee, Resource West, Inc., provide examples.

Although this approach has met with substantial success, it is limited in some applications in that the impellers used in such systems in many cases have been relatively inefficient in some applications.

### SUMMARY OF THE INVENTION

To address these limitations and to advance the art, and in accordance with the purposes of the invention as embodied and broadly described in this document, an impeller design is provided for use in evaporating water from an ambient water body. The impeller according to one aspect of the invention comprises a hub and a plurality of impeller blades. The blades have one or more profiles that correspond to certain profiles characterized by the National Advisory Committed for Aeronautics parameters known as NACA 4 parameters. One or more blade angles also may more specifically identify the blade profiles. Preferably, the impeller blades are identified by a plurality of profiles on a given blade, preferably including a base profile and a tip profile.

The impeller optionally but preferably comprises or consists essentially of a fiberglass material. Optionally but preferably, the impeller, including the hub and the blades, comprise an integrated unit, such as a unitary molded or cast unit. In presently-preferred embodiments, the fiberglass material is treated or coated by a suitable corrosion-resistant coating, for example, such as a clear coat or gel coat.

In presently-preferred embodiments, there are between 8 and 12 blades, or 18 blades, on the impeller. In the preferred embodiments disclosed herein, there are eleven identical impeller blades disposed uniformly or symmetrically around the periphery of the hub, referred to herein as the hub flat. The blades preferably have a length such that the tip of the blades is minimally spaced from the interior wall of the flow channel in which the impeller is contained.

The impeller hub preferably comprises a concavity in its central upstream portion. This concavity beneficially adapts the flow characteristics of the air flow as it approaches the impeller, as further explained herein below. The hub also preferably comprises a non-perpendicular edge at its upstream edge that similar provides advantageous aerodynamic or fluid mechanical features. The hub also preferably comprises an upstream offset of the upstream edge or plane of the impeller blades with respect to the upstream edge of the hub.

An impeller system in accordance with another aspect of the invention also is disclosed herein. The system comprises an impeller or impellers as described herein, and further comprises means for mitigating non-longitudinal flow in the air flow channel in which the impeller caused air movement. In presently-preferred embodiments, the means for mitigating non-longitudinal flow comprises a plurality of guide vanes disposed downstream of the impeller. Preferably the leading edge of the guide vanes are disposed immediately downstream of the impeller.

### BRIEF DESCRIPTION OF THE DRAWINGS

The accompanying drawings, which are incorporated in and constitute an integral part of the specification, illustrate presently-preferred embodiments and methods of the invention and, together with the general description given above and the detailed description of the preferred embodiments and methods given below, serve to explain the principles of the invention. Of the drawings:

FIG. 1 is a perspective view of a water body, and more specifically an impoundment pond, in which an evaporator according to an aspect of the invention is positioned for operation;

FIG. 2 is a side cutaway schematic view of an evaporator that embodies an impeller and impeller system according to an aspect of the invention;

FIG. 3 is a side cutaway schematic view of another evaporator that embodies an impeller and impeller system according to an aspect of the invention;

FIG. 4 is a perspective view of an impeller according to a presently-preferred embodiment of an aspect of the invention;

FIG. 5 is an upstream longitudinal view of the impeller of FIG. 4;

FIG. 6 is a side cutaway view of the impeller of FIG. 4, viewed along lines A-A as indicated in FIG. 5;

FIG. 7 is a magnified or detailed cutaway view of the hub axle area of the impeller of FIG. 4, as indicated by the area marked as B in FIGS. 5 and 6;

FIG. 8 shows a hub axle insert for the impeller of FIG. 4;

FIG. 9 is an upstream longitudinal view of the impeller of FIG. 4 similar to FIG. 5, but wherein another hub axle assembly is incorporated;

FIG. 10 is an exploded perspective view of the hub axle assembly shown in FIG. 9;

FIG. 11 is a perspective view of the hub axle assembly of FIG. 10 in assembled form;

FIG. 12 is a magnified or detailed cutaway view of the hub “flat” area of the impeller of FIG. 4, as indicated by the area marked as C in FIG. 6;

FIG. 13 is a side cutaway view of the impeller of FIG. 4, and includes an expanded and detailed view of the upstream outer corner of the hub, which includes a non-perpendicular corner edge;

FIG. 14 shows an adjustable and detachable impeller blade coupled to the hub for the impeller of FIG. 4;

FIG. 15 is a top schematic view of the impeller of FIG. 4, and illustrates angles of the impeller blades relative to the rotational plane of the hub;

FIG. 16 is a top plan longitudinal view of the impeller of FIG. 4, and illustrates reference planes useful in characterizing features of the impeller, its blades and their configuration on the hub;

FIG. 17 is a perspective view of an impeller blade for the impeller of FIG. 4;

FIG. 18 is a side cutaway view of the impeller blade of FIG. 4, viewed from the base or hub area outwardly along the length of the blade toward the blade tip area from the perspective as indicated by arrows D-D in FIG. 17;

FIG. 19 is a side cutaway view of the impeller blade of FIG. 4, viewed from the blade tip area inwardly along the length of the blade and toward the hub from the perspective as indicated by arrows E-E in FIG. 17;

FIG. 20 is a schematic diagram that illustrates variables and parameters used in describing aspects of the invention and related presently-preferred embodiments;

FIG. 21 is a side view of the hub for the impeller of FIG. 4, but wherein only a single blade is attached;

FIG. 22 is a view of the impeller blade shown in FIG. 21, but with the superposed views of the blade in FIG. 21 positioned side by side;

FIG. 23 is a perspective view of the impeller of FIG. 4 with three rectilinear planes superposed over the impeller to illustrate features;

FIG. 24 is a side view of the impeller of FIG. 4, with portions of the rectilinear plane system of FIG. 23 superposed on it;

FIG. 25 is a side view of the impeller of FIG. 25 that includes two illustrative blades and a reference angle theta (θ);

FIG. 26 is a side view of a base profile for one of the blades of FIG. 25;

FIG. 27 is a side view of a tip profile for one of the blades of FIG. 25;

FIG. 28 is an impeller blade profile that illustrates the configuration of the blade relative to the rotational plane of the impeller hub;

FIG. 29 is an impeller blade profile that also illustrates the configuration of the blade relative to the rotational plane of the impeller hub;

FIG. 30 is a perspective view of an impeller system including an impeller housing according to a presently-preferred embodiment of another aspect of the invention;

FIG. 31 is a longitudinal view of the impeller system of FIG. 30, viewed from an upstream position and viewing it in a downstream direction, as indicated by arrow F in FIG. 31;

FIG. 32 is a side cutaway view of the impeller system of FIG. 30;

FIG. 33 is a side cutaway view of the impeller system of FIG. 28 similar to FIG. 32, and illustrates the positioning of guide vanes downstream of the impeller; and

FIG. 34 is a perspective view of a guide vane.

### DETAILED DESCRIPTION OF THE PREFERRED EMBODIMENTS AND METHODS

Reference will now be made in detail to the presently-preferred embodiments and methods of the invention as illustrated in the accompanying drawings, in which like reference characters designate like or corresponding parts throughout the drawings. It should be noted, however, that the invention in its broader aspects is not limited to the specific details, representative devices and methods and illustrative examples shown and described in this section in connection with the preferred embodiments and methods. The invention according to its various aspects is particularly pointed out and distinctly claimed in the attached claims read in view of this specification, and appropriate equivalents.

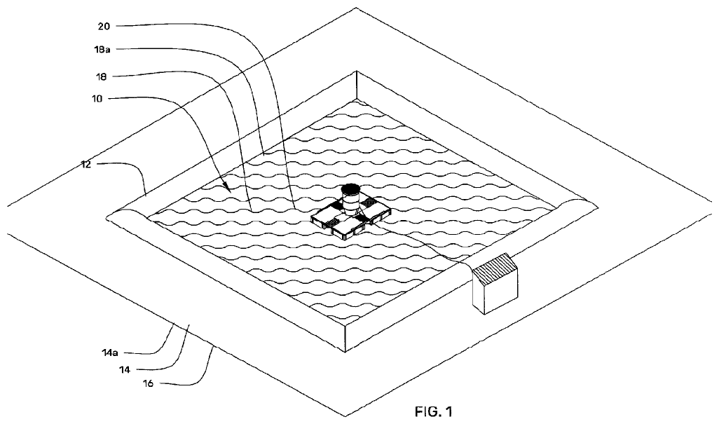

Evaporators that employ impellers, impeller systems and methods according to the various aspects and embodiments of the invention are useful for evaporating water from such water bodies as ponds, lakes, rivers, impoundment ponds, flooded regions, and the like, as noted above. To provide an illustrative example, and with reference to FIG. 1, a water body in the form of an impoundment pond 10 is shown in perspective view. Pond 10 is of the type that is commonly found at or near oil and gas drill sites, mining operations, and the like. It is surrounded at its perimeter by a berm or ledge 12. A plastic or other water-impermeable liner 14 is disposed on the bottom and side surfaces of the pond, over berm or ledge 12 and to an outer perimeter 16. Liner 14 thus retains water 18 within the pond and, by virtue of the liner portion surrounding the pond from the berm or ledge 12 to the outer perimeter, (referred to herein as an “apron 14a”), protects the ground from spills, pond overruns, and the like.

An evaporator 20 comprising an impeller, for example, according to any of the various embodiments disclosed herein, is disposed on the surface 18a of the water 18 within the pond, in this illustrative example roughly in the center of the pond.

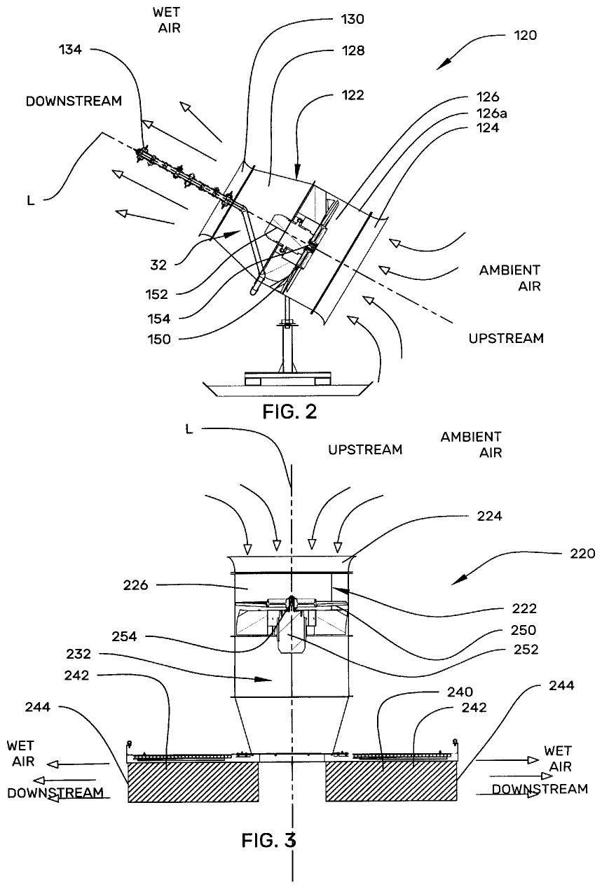

An example of an evaporator that can employ impellers, impeller systems and related methods according to various aspects of the invention is shown in FIG. 2. With reference to that drawing figure, an evaporator 120 includes a housing 122 having an upstream end for receiving ambient air and a downstream end that discharges a stream of the ambient air. Starting at the upstream end, housing 122 comprises an inlet bell assembly 124, a fan case assembly 126 (including a fan case housing or fan casing 126a), an outlet cone assembly 128, and an outlet bell 130. Each of these components is disposed about a longitudinal axis L and is in fluid communication down the interior length of housing 122 to form an air flow channel 132. Air flow channel 132 extends longitudinally through the interior length of housing 122. A water distribution device 134 is positioned at the downstream end of housing 122 to receive water from the water body and to spray that water into the air flow stream emerging from air flow channel 132.

An impeller according to an aspect of the invention, e.g., such as impeller 150, is fixedly positioned within fan case housing 126a proximate to the upstream end of housing 122. Impeller 150 is positioned and configured to induce the flow of ambient air into housing inlet bell 124 at the upstream end, through air flow channel 132 and out the downstream end of housing 122 at outlet bell 130. As the air flow emerges from the downstream end, water injection device 134 injects water into the air stream from outside the air stream or more preferably from within the air stream. This causes the wetted air that has emerged from downstream end to be projected into the air to form a plume. As the water droplets and water vapor in this plume traverse the plume trajectory, they undergo evaporation.

Incidentally, in describing the preferred but merely illustrative embodiments and methods in this document, it will be convenient to use the relative terms “upstream” and “downstream” to describe the flow or air within the devices, to describe the relative locations of device components and locations relative to one another along the air flow channels, to describe relative directions or movement, and so on. Accordingly, as used herein, the term “downstream” refers to the direction in which the bulk air flows within the evaporator. With respect to the housing, bulk air flow is from the air intake end to the air outlet. Conversely, the term “upstream” means the direction opposite of downstream.

Another evaporator 220 that also illustrates the incorporation and use of impellers, impeller systems and related methods according to various aspects of the invention is shown in FIG. 3. Evaporator 220 comprises an upstream end for receiving ambient air and a downstream end that discharges a stream of the ambient air. Evaporator 220 comprises a housing 222 and a float assembly 240 at the downstream end of housing 220. From the upstream end, housing 222 comprises an inlet bell assembly 224, a fan case assembly 226 comprising fan case housing 226a, and an outlet cone assembly 228. Each of these housing components is disposed about a longitudinal axis L and is in fluid communication down the interior length of housing 222 to form an air flow channel 232.

Housing 222 is fixedly disposed on float assembly 240, which floats on the surface of the water in the water body. Float assembly 240 includes a float assembly flow channel 242 that is in fluidic communication with housing air flow channel 232 so that, as the air moves downstream, it exits housing air flow channel 232 and immediately enters float assembly air flow channel 242. The air then continues down float assembly flow channel 242, in both directions of that flow channel, whereupon it exits float assembly flow channel exits 244. Optionally but preferably, a water distribution device 234 may be positioned at the downstream end of housing 222, within float assembly air flow channel 242, at float assembly flow channel exits 244, or some combination of these. The water distribution device, which may and preferably does comprise a plurality of water-injecting nozzles, sprays water into or within the air flow stream emerging from housing air flow channel 232, the float assembly air flow channels 242, the float assembly air flow channel exits 244, or a combination of these.

As with evaporator 120, evaporator 220 comprises an impeller 250 and more preferably an impeller system such as the presently-preferred embodiments described herein. Impeller 250, which in this illustrative example is disposed proximate to the upstream end of housing 222, generates a downwardly-flowing air stream, drawing in relatively-warmer and dryer ambient air from above evaporator 220 into inlet bell 224. It directs that air downwardly through housing air flow channel 232, into float assembly flow channel 242, and out the exits 244, all in the downstream direction.

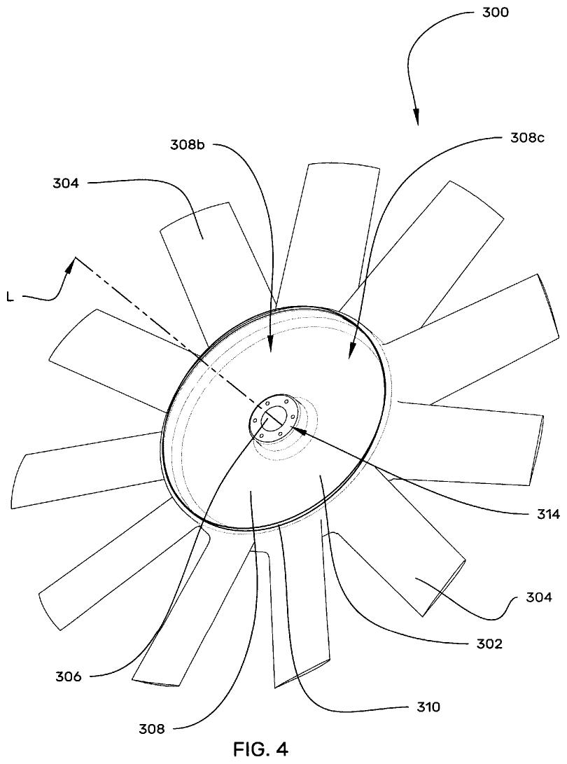

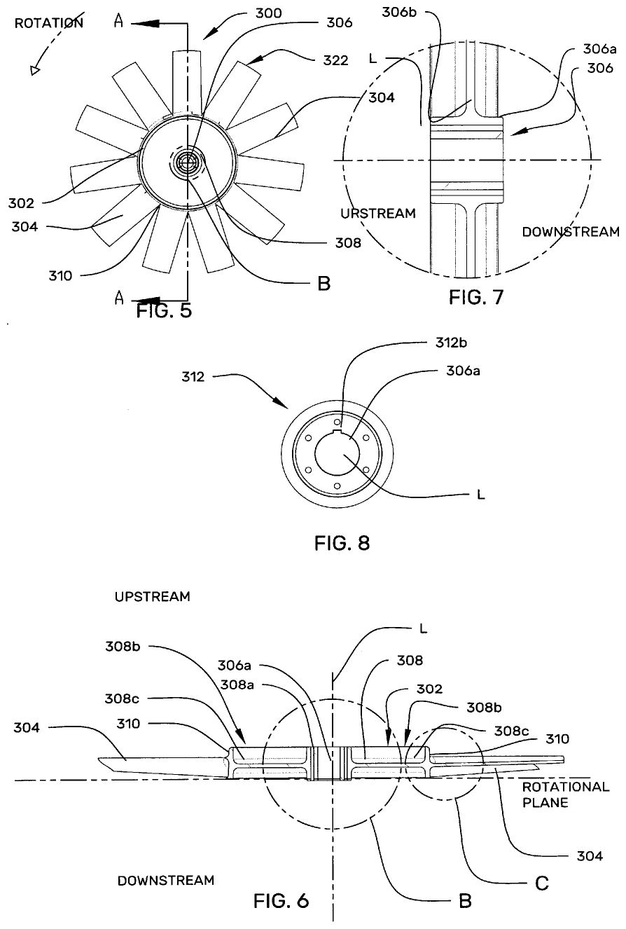

An impeller 300 according to a presently-preferred embodiment of an aspect of the invention, shown in perspective view in FIG. 4, will not be described. An upstream longitudinal view of impeller 300 is provided in FIG. 5, and a partial cutaway side view taken orthogonally with respect to longitudinal axis L along the lines designated as A-A in FIG. 5 is provided in FIG. 6.

Impeller 300 is designed to induce air flow from the upstream side of the impeller toward or to its downstream side, for example, as indicated in FIGS. 2 and 3. Impeller 300 is suitable for use in evaporation equipment, for example, such as evaporators 120 and 220 as described herein above, as well as others.

Impeller 300 comprises a hub 302 disposed about a longitudinal axis L at a central portion of the impeller and a plurality of impeller blades 304 extending outwardly radially from hub 302.

The hub in this and similar embodiments functions to mechanically support and position the blades in the housing flow channel of the evaporator, and to translate mechanical forces, primarily the rotational forces applied at the hub axle, to the blades. Hub 302 comprises a hub axle 306, a hub body 308, and a hub perimeter or flat 310.

The hub axle, in addition to being the center point on the hub and on the impeller for rotation and being the center of rotation for the impeller, is the sole or primary means for coupling the hub and the impeller to a mechanical drive means for rotating and thus driving the impeller. Examples of the mechanical drive means are described herein below but, for example, would include an electric motor, a pneumatic, hydraulic or fluidic drive system, a belt- or chain-drive system, and the like. The presently-preferred mechanical drive means for impeller 300, although not necessarily limiting, comprises an AC induction motor having a motor shaft. As examples, evaporator 120 in FIG. 2 comprises a motor 152 with shaft 254, and evaporator 220 in FIG. 3 comprises a motor 252 with shaft 254.

Hub axle 306 according to one embodiment comprises an aperture 306a disposed at the longitudinal center L of impeller 300, as shown, e.g., in FIG. 7. Aperture 304a may be of any shape that is capable of mating with the motor shaft or other drive means but preferably in this embodiment is circular. It is sized to fit over the motor shaft or other drive means attachment mechanism. Aperture 306a comprises a notch 306b on its interior surface, as shown in FIG. 8. Notch 306b is configured with respect to shape and size to receive a corresponding pin on the motor shaft or other drive means attachment mechanism. If the circumstances and operating conditions warrant or if otherwise desired, a plurality of such notches may be provided.

As a modification of this embodiment, hub axle 306 may comprise a relatively larger aperture that, instead of receiving the motor shaft or other drive means attachment mechanism directly, receives a shaft collar insert 312, e.g., as shown in FIG. 8. Shaft collar insert 312 is fixedly inserted into aperture 306a and secured, e.g., by press-fit, notches, adhesive bonding, welding, sonic or acoustic welding, or the like. Shaft collar insert 312 itself also preferably includes a notch 312b such as notch 306b on its interior to engage and lock the motor shaft or other drive means attachment mechanism.

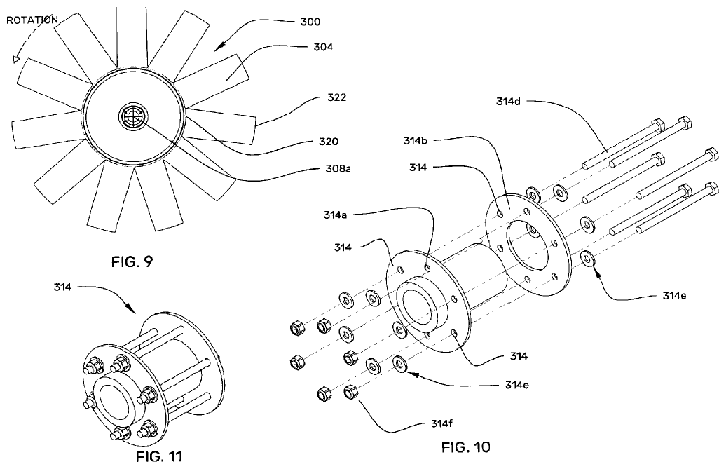

Another arrangement for the hub axle 306 of impeller 300, more specifically an impeller flange bracket assembly 314, is shown in FIGS. 9-11. FIG. 9 shows a front or longitudinal view of impeller 300 with bracket assembly 314 disposed at the center axial position at hub axle 306. As shown in the perspective exploded view of FIG. 10, bracket assembly 314 comprises an impeller flange bracket 314a and a mating impeller flange 314b. Impeller flange bracket 314a and impeller flange 314b are constructed from a strong, tough and rigid material that resists wear and corrosion. Ideally the impeller flange bracket and impeller flange are made of the same materials, or at least have the same surface materials, e.g., to avoid electro-chemical effects or interactions, particularly where metallic materials are used. Examples of suitable materials would include stainless steel, aluminum, galvanized steel and various plastics. In this presently-preferred embodiment, both impeller flange bracket 316a and impeller flange 316b are constructed of stainless steel.

Impeller flange bracket 314a and impeller flange 314b include a plurality of mating holes 314c. Corresponding holes 308a are provided in hub body 308 adjacent to hub axle aperture 306a, as illustrated, for example, in FIG. 9. Once impeller flange bracket 314a and impeller flange 314b are inserted into aperture 306a of hub 302 and are in mating arrangement as shown in FIG. 10, and with the mating holes of the impeller flange bracket, suitable fasteners, e.g., in this embodiment bolts 314d with mating washers 314e and nuts 314f are used to fasten and secure impeller flange bracket 314a and impeller flange 314b together on hub 302. Impeller 300 with this impeller flange bracket assembly thus is ready to be mounted on the motor shaft or other drive means attachment mechanism. One or more notches such as notch 306b also may be provided in the interior surface of impeller flange bracket for mating and securing the bracket assembly to the motor shaft or the like.

Hub body 308 provides mechanical coupling, rigidity and strength between the axle 306 and the blades 304. It also serves to properly position the blades, e.g., in the housing flow channel 132 in FIGS. 2 and 232 in FIG. 3. Hub body 308 in impeller 300 comprises a solid planar or substantially planar circular plate having an upstream surface and a downstream surface. Hub body 308 is perpendicular or substantially perpendicular to longitudinal axis L and rotates in a rotational plane, described more fully herein below.

Hub perimeter wall or flat 310 is disposed at a fixed radial distance around hub body 308 and it is fixedly attached to or integrally formed as part of the outer portion of hub body 308. Hub perimeter or flat 310 can serve a number of advantageous roles functions. It serves as a mechanical attachment point and support for the respective blades 304. It also may serve to advantageously direct and condition the air flow, particularly at the upstream side of impeller 300.

In impeller 300, at the upstream side of hub 302 and more specifically at an upstream hub side area 308b, hub 302 comprises a concave region 308c. This concave region 308c, as shown, for example, in FIGS. 4 and 6, preferably comprises most of if not essentially all of this upstream hub side area 308b. Preferably it comprises between about 60% to about 90% of the upstream hub side area, and more preferably between about 70% to about 80% of the upstream hub side area. Concave region 308c preferably is free of a structural obstruction that would interfere with direct contact of the air at the upstream side of the hub.

When impeller 300 is in use and rotating at the desired rotational speed, particularly at rotational frequencies above about 1,200 rounds per minute (“RPM”) but depending on such things as the impeller size, blade configurations and so on, the circular rotation of the hub and more particularly circular concave region 310c causes a substantially-circularly rotating air flow to occur at this region immediately upstream of the hub. This circular air flow is tantamount to a stagnant flow or dead space with respect to flow through the air flow channel. Incoming air flowing into the impeller is affected by this stagnant flow or dead space and must move around it. Where this phenomenon has arisen in other contexts, such as aircraft propellers, a nose cone has been placed in the region where the dead space otherwise would have occurred to physically force the air flow around the space. This approach could be used in connection with embodiments according to this aspect of the invention, but the inventors have ascertained that this alternative approach or design is not only available but generally preferred.

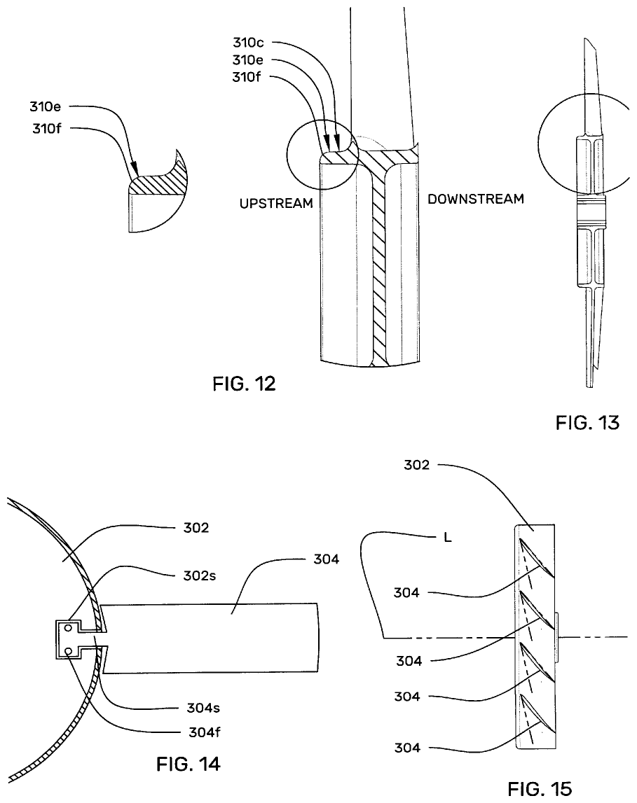

In presently-preferred embodiments, the upstream edges or profile of the blades is offset toward the downstream side relative to the upstream edge or profile of the hub. In the embodiments shown and described herein, an offset 310c is provided, for example, as shown in FIGS. 6 and 12. The offset preferably is disposed at a distance downstream of the upstream profile of the hub sufficient to avoid the center spin of the air. The offset 310c in a specific design or embodiment can be expressed as a distance from the plane of the upstream edge of the hub flat 310. Offset 310c also may be expressed as a percentage of hub depth, wherein the hub depth is the distance from the midpoint 310d intersection of the hub body in the rotational plane and hub flat 310. In the latter case, the offset preferably is at least about 10% of the hub depth. In illustrative impeller 300, the offset 312 is one inch.

In impeller 300 and similar embodiments, the inventors have developed a non-perpendicular edge design that can provide significant advantages. In this design, and with reference to FIGS. 12 and 13, the outer corner 310e of the perimeter wall 310 of hub 302 at the upstream side of the hub comprises a non-perpendicular edge, for example, which may comprise a bevel, taper, chamfer, rounded corner, a bull nose edge, and the like. Where a rounded corner is employed, it preferably comprises a radial curvature between about one quarter of an inch and about one half of an inch for an impeller having a diameter of about 42 inches and a hub having a diameter of about 18 inches.

Although not wishing to be bound to any particular theory of operation, the inventors believe that this bull nose aids in avoiding the creation of turbulence in the upstream air before it comes into contact with the impeller blade. In circumstances where the bull nose is insufficiently rounded or non-perpendicular, the air flowing across the edge of the hub generally becomes more turbulent and the efficiency of the impeller is reduced. In impeller 300, this non-perpendicular edge comprises a bull nose edge 310f. It can be advantageous in some designs according to this aspect of the invention, particularly where the impeller or hub is to be manufactured as a molded structure, that the longitudinally outer edges be tapered to facilitate the molding process and to avoid issues that can arise when molding items with sharp corners.

Hub diameter can play a significant role in the efficiency of the impeller. It directly impacts the blade solidity and the power required to move the air. By adjusting the hub body diameter to be smaller or larger, the length of the blade and size of the dead zone in front of the hub can be changed. In some presently-preferred embodiments, a hub body diameter of between about 16 and 22 inches is preferred. Hub body 308 has a diameter of 18 inches.

The weight of the impeller plays a relatively minor role in its function outside of initial startup, but allows for easier physical manipulation during installation and maintenance. It is also less dangerous in case of catastrophic failure.

In impeller 300, the balance of the impeller preferably is axially uniform or symmetrical and is slightly heavier toward the downstream side based on the design of the hub flat 310 as described herein.

The impeller blades 304 are coupled to hub perimeter or flat 310 and are uniformly spaced about the hub flat 310, e.g., as shown in FIG. 5. Impellers according to this aspect of the invention may have between eight and twelve impeller blades and alternatively eighteen blades, preferably spaced equally or uniformly around the perimeter of the hub. In impeller 300, there are eleven impeller blades disposed uniformly around hub perimeter 310. It is helpful, particularly where the impeller is made through a molding process, that the impeller blades have little overlap between one another. The number of blades on the impeller typically involves a balancing or comprise between desired air flow, drag, blade volume and ease or cost of manufacture.

Impeller blades according to this aspect of the invention may be coupled to the hub such that the blades are movable with respect to the hub. The blades may be movable in the sense that they are rotatable about one or more axes of the respective blades themselves, and with respect to the rotational plane of the impeller. For a given impeller, some blades may be movable and others not, for example, where alternating blades are movable to adjust blade pitch and the remaining blades are fixed. The impeller blades also may be detachable from the hub. Detachability provides the potential benefit of being able to change blades, e.g., to obtain different operational or performance characteristics of the impeller, to replace worn or damaged blades, and the like. Movability or adjustability, such as the ability to rotate or move the blades on the hub, affords the potential advantage of being able to adjust or tune the geometry of the blades with respect to the air flow or air flow regime, thus improving the operational or performance characteristics of the impeller.

To illustrate, an embodiment of impeller 300 that comprises movable, detachable and adjustable blades is shown in FIG. 14. In this blade-attachment embodiment, hub 302 comprises a slot or well 302s and blade 304 comprises a stanchion or post 304s that mates with hub slot 302s. Fasteners here in the form of bolts 304f secure blade 304 onto hub 302 at this location. Where one wishes to make the blades movable, one may insert spacers in the well 302s. Alternatively or in addition, one may provide for bolt holes and bolts through the hub flat 310 adjacent to the axis of blade 304 so that, when loosened the blade can be rotated, e.g., as shown in FIG. 15, and when the desired blade angle is achieved, one may tighten the bolts to lock the blade into position at that blade angle. With reference to FIG. 15, blades 304 are shown in an initial position, indicated by the solid lines, but may be rotated to a rotated position indicated by the dashed lines.

As noted in the immediately preceding disclosure herein above, the impeller blades may comprise physically-separate components of the impeller with respect to the hub. In some applications, for example, such as where the potential advantages noted above are important, this may be preferred. Manufacturing impellers according to preferred embodiments of this aspect of the invention can provide advantages, for example, in providing relatively lighter, smoother, cheaper and more corrosion-resistant products. It also may improve manufacturability and mitigate manufacturing, operational and durability concerns.

In other applications, however, the impeller comprises or consists essentially of a single integrated body in which the hub and the impeller blades are integrally formed. One approach to achieving this integrated design involves producing the hub and impeller blades separately but bonding or joining them to form an integrated structure, for example, by welding, adhesive bonding or the like. In another approach, some or all of the blades and the hub are integrally formed or constructed, e.g., in a single molding or casting process.

Materials for impellers according to certain presently-preferred embodiments ideally are strong, rigid, tough, and corrosion resistant. Strength and rigidity generally are desired if not required to move the air appropriately through the evaporator or evaporation system. This is particularly true where, as further described herein, the tolerances between components, e.g., between the downstream edge of the impeller blades and associated guide vanes, are tightly controlled. Strength and rigidity also generally are required for good durability. Toughness is a generally desirable characteristic, e.g., given that stresses will be placed on the impeller components, particularly the blades and blade attachments to the hub. Instances also may occur in which unwanted debris may be drawn into the impeller and may adversely impact the blades.

Where the blades are movable, i.e., detachable, rotatable and the like, the hub and blades may or may not constitute or comprise the same materials. The same is true where the hub and blades are integrally formed or comprise a solid construction. In the latter instances, however, the use of uniform or homogenous material composition and construction is more frequently desired, even though dimensions and thicknesses vary from point to point, e.g., for structural strength and rigidity.

Because impellers according to this aspect of the invention are used in environments where water is present, i.e., in relatively high-humidity ambient environments, corrosion often will be an issue. It also is not at all uncommon for the water to be evaporated to have relatively high ion or solute concentrations, e.g., such as salt or brine content, high acidity or alkalinity, and the like. It therefore can be important to design the impeller and its components to be corrosion-resistant. This may be accomplished, for example, using suitable corrosion-resistant materials in their construction. Preferred but merely illustrate examples would include polymeric or resin-based materials. A presently-preferred material for construction of both hubs and impeller blades is fiberglass and fiberglass-containing materials. Certain metallic materials that have relatively good corrosion resistance, for example, such as various stainless steels, aluminum, aluminum alloys and the like, also may be preferred, depending on the operational environment, the specific application, and so on.

Another means of providing corrosion resistance involves the use of surface coatings. Corrosion-resistant surface coatings such as waterproof or water-resistance paints, resins, clear coats, gel coats and the like are examples.

A presently-preferred material composition, especially where a single integrally-molded impeller body is used, and more especially where such impeller is used in a highly-corrosive, high-dissolved solids environment, comprises or consists essentially of a coated fiberglass or coated fiberglass-containing material, preferably coated with a suitable material, for example, such as a gel coat.

As implemented in impeller 300 according to this presently-preferred embodiment, the impeller is integrally molded as a single, substantially homogeneous body including hub 302 and blades 304 using a resin-impregnated fiberglass material. After suitable trimming and shaping when and if appropriate, the fiberglass body is coated with a hardened gel coat.

Thus, in many applications it is desirable to select materials that are compatible with the operational environment, such as water- and corrosion-resistance, resistance to the variety of chemicals and pH ranges that will be encountered, etc., while being resistant to stress cracks and other mechanical fatiguing issues.

In this presently-preferred embodiment, the integrated impeller blade and hub comprise, and preferably consist essentially of, a coated fiberglass.

Presently-preferred impeller blades according to this aspect of the invention are designed to be particularly well suited for the task of efficiently and effectively moving air to facilitate evaporation of water from a water body in an ambient environment. An aspect of achieving these features in many presently-preferred embodiments involves the shape and contour of the impeller blades, and their positioning with respect to the air flow channel. For embodiments that have a single shape or cross-sectional shape profile down the length of the blade, the blade may be characterized with respect to shape by merely providing that profile. In many presently-preferred embodiments according to this aspect of the invention, however, the shape or cross-sectional profile varies down the length of the blade and therefore a plurality of profiles or a mathematical profile function or relationship generally is required.

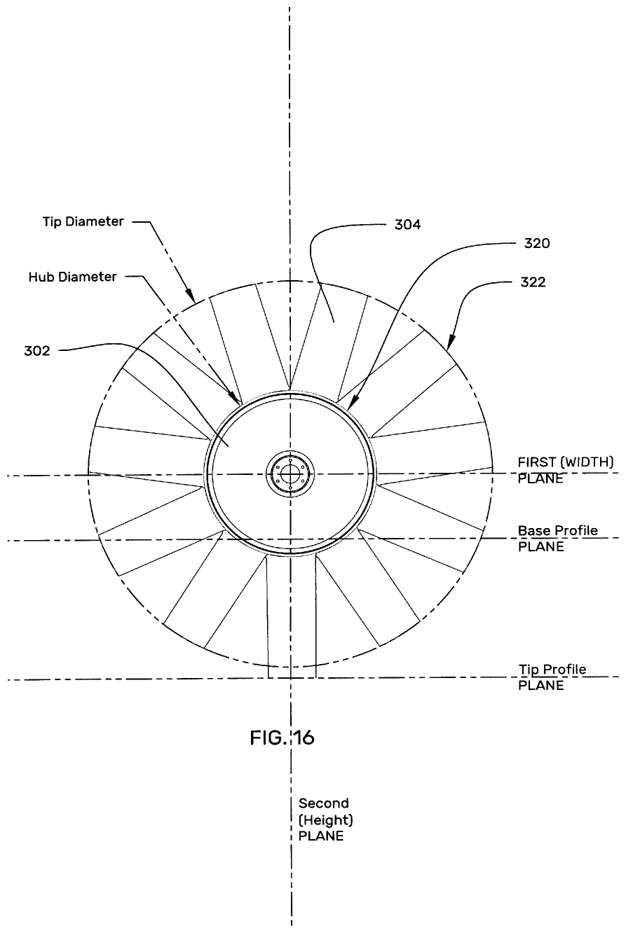

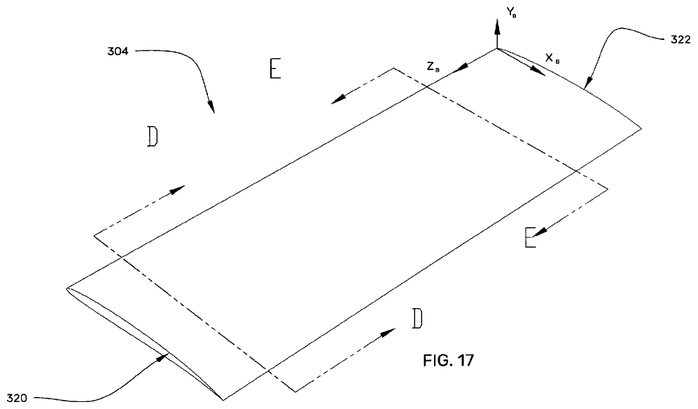

With reference to FIG. 16, which shows an upstream longitudinal view of an impeller such as impeller 300 of FIG. 9, each impeller blade comprises a proximal end 320 at or proximal to the hub and a distal end 322 at its outer radial end. The proximal end 320 also is referred to herein as the base of the impeller blade, and the distal end also is referred to herein as the blade tip.

A single blade from the impeller of FIG. 16, e.g., blade 304 from the impeller 300, is shown in perspective view in FIG. 17. As shown in FIG. 17, the proximal or base end 320 of blade 304 is at the lower left side of the drawing figure, and the distal end or blade tip 322 is at the upper right side.

Similarly, given the radial or cylindrical shape of the fan casing or housing in which the impeller typically would be disposed, for example, such as fan casing 126a of FIG. 2 or fan casing 226a in FIG. 3, blade tip 322 preferably is rounded or otherwise appropriately contoured to conform to the interior surface of the casing or housing. In presently-preferred embodiments, the length of the impeller blade is selected so that the blade tip 322 nearly touches the interior housing wall, leaving only a narrow gap between the blade tip 322 and the interior housing wall, preferably along the entire length of the blade tip from leading edge to trailing edge. In presently-preferred impeller 300, for example, fan casing 126a of evaporator 120 (FIG. 2) has an interior diameter of 42 inches (a radius from longitudinal axis L to the interior wall of fan casing 126a of 21 inches), and impeller 150 (identical to impeller 300) has a radius (longitudinal axis L to blade tip 322) of 20 15/16 inches, thus providing a gap between blade tip 322 and the interior housing wall of only 1/16 inch. Hub 302 and more specifically hub flat 310 has a radius relative to longitudinal axis L of 9 inches (the hub diameter being eighteen inches), so in this embodiment each of the blades has a length of 11 15/16 inches.

In some embodiments, as noted herein above, the impeller may have a uniform cross-sectional shape down the length of the blade. Thus, if a cross sectional profiles are taken at D-D and E-E in FIG. 17, they would be the same. In presently-preferred embodiments, however, the profiles at such blade length locations would differ.

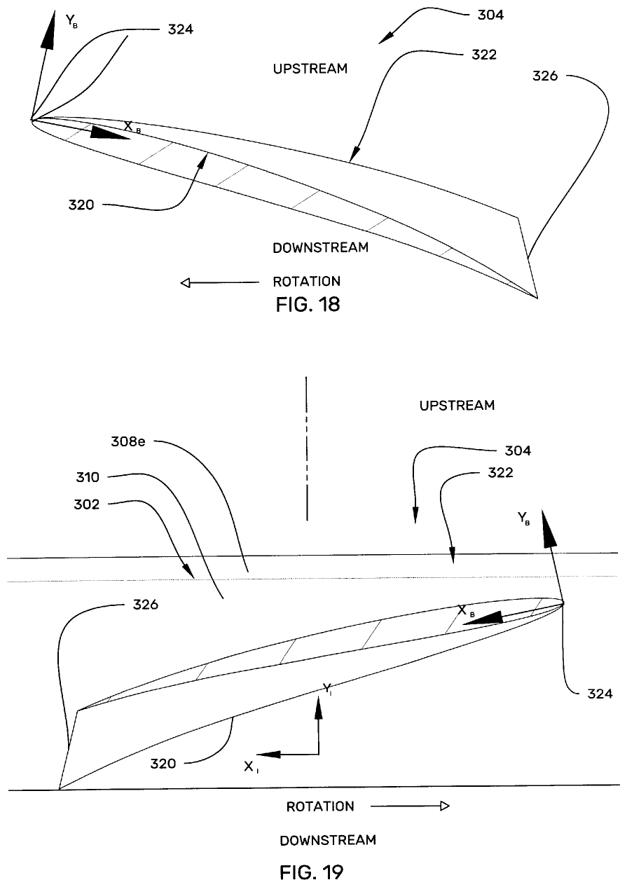

To illustrate, FIG. 18 shows a perspective view of impeller blade 304 viewed from base 320 outwardly toward blade tip 322, as reflected by arrows D-D in FIG. 17. Similarly, FIG. 19 provides a perspective view of blade 304 viewed from blade tip 322 inwardly toward base 320 and hub 302 as reflected by arrows e-e in FIG. 17. From these perspectives it can be seen that the curvature of the blade 304 is relatively more pronounced proximate to the hub 302, and becomes progressively less curved as one moves down the length of the blade toward blade tip 322. It will be noted that in blade 304 the leading edge 324 of the blade lies along a line projecting radially outward from hub 302 perpendicular to longitudinal axis L (characterized herein below as the z_{B}-axis). The trailing edge 326, however, has a noticeable curvature that is relatively more pronounced or greater at the proximal end 320 adjacent to hub 302 than it is in the distal region adjacent to blade tip 322. Viewing blade 304 from the blade tip 322 inwardly toward hub 302 (FIG. 19), for example, the leading edge 324 and trailing edge 326 (the cross-hatched area) lie relatively parallel to the upstream edge or plane of hub 302. At the intersection of the blade 304 and hub flat 310 at and around base 320, e.g., at the cross-hatched area shown in FIG. 18, the trailing edge 326 is relatively significantly more curved.

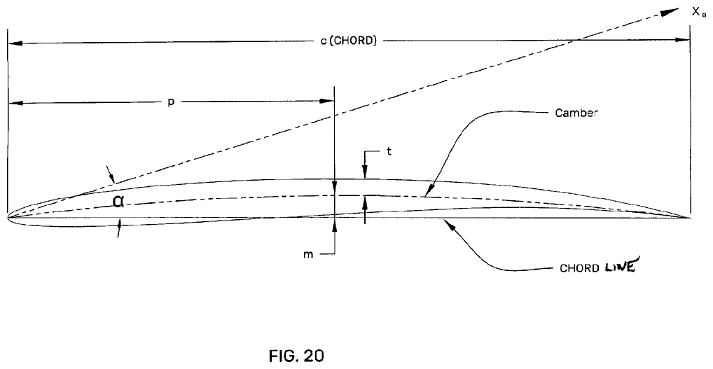

There are a number of techniques or technical approaches for characterizing the shape or geometry of aerodynamic surfaces such as airfoils, propellers, fan or impeller blades and the like. One such approach, and the one used herein to characterize blades according to aspects of the invention and its presently-preferred embodiments is the National Advisory Committee for Aeronautics (“NACA”) (the predecessor to the U.S. National Aeronautics and Space Administration) NACA 4 formulation. The NACA 4 approach or method uses three parameters expressed as a four-digit number or expression to characterize the shape of an aerodynamic surface body, and more specifically, a cross-sectional aerodynamic surface body shape profile. These parameters are identified on an illustrative or generalized aerodynamic surface in FIG. 20.

As a preliminary matter, one must understand several features or characteristics of an aerodynamic surface (e.g., an airfoil or impeller) that define its shape profile. The shape profile is a profile of the cross-sectional shape of the aerodynamic surface, including its upper surface and its lower surface. The aerodynamic surface includes a leading edge, a trailing edge, an upper surface extending from the leading edge to the trailing edge, and a lower surface also extending from the leading edge to the trailing edge. The leading edge is the forward-most portion of the surface, and the trialing edge is the rear-most portion. The “chord line” of an airfoil or impeller is a straight line between the leading edge and the trailing edge of the surface. The line itself is referred to as the “chord line” and its length is referred to as the “chord.”

The “camber” or “camber line” is the locus of points from the leading edge to the trailing edge that are midway between the upper surface and the lower surface measured orthogonally with respect to the chord line. The “thickness” (t) is the distance between the upper and lower surfaces. Thickness typically is represented as a mathematical function or expression that reflects or maps the locus points between the upper and lower surfaces measured orthogonally with respect to the chord line from the leading edge to the trailing edge. There is a thickness value for each point along the chord line and, similarly, these thickness values can be expressed as a plot of thickness values as a function of the position on the chord. The “maximum camber” (Cₘₐₓ) is the location on the camber line where the camber is at its maximum, i.e., the distance normal to the chord line where the camber line is at its furthest point relative to the chord line. The term “maximum camber” also is used to refer to the distance from the chord line to the maximum camber location on the camber line measured normal to the chord line. The “maximum camber position” (X_{Cmax}) is the position on the chord line where the maximum of the camber occurs, as measured orthogonally with respect to the chord line.

The NACA 4 system uses three parameters based on the maximum camber, the maximum camber position and the thickness, to generate the four-digit NACA 4 number that characterizes the profile of an airfoil or impeller. This airfoil characterization system is generally available in the publicly-available literature. The descriptions and uses applicable here follow those publicly-available descriptions, but given their public availability only a summary is provided herein.

The three-parameter, four-digit NACA 4 system for designating an impeller shape profile is expressed as MPXX, where:
M is the maximum camber Cₘₐₓ expressed as a percentage of the chord C;
P is the position of maximum camber (the length or distance from the leading edge to the position on the chord line where the maximum camber occurs, X_{Cmax}), expressed in terms of tenths of the chord; and
XX is a two-digit number that reflects the maximum thickness of the airfoil or impeller, expressed as a two-digit percentage of the chord.
   To illustrate with an example, if the chord C is one foot, Cₘₐₓ is 0.05 ft., X_{Cmax} is 0.4 ft., and the maximum thickness is 0.13 ft., then M=5 (0.5/1.0×100), P is 4 (0.4/1.0×100), and XX is 13 (0.13/1.0×100), and thus the NACA 4 expression would be 5413.

Incidentally, C as used here has been remapped to c so that C=c for ease of use in the equations.

In view of the common use of percentages of the chord in the NACA 4 expressions, we can define the following variables for M, P and t:

m=Max Camber percentage (M/100)

p=Percentage of Setback (P/10)

t=percentage of thickness (xx/100)

### Rotation

alpha (or α)=rotation of chord in −\hat{k} direction in respect to the X axis

The NACA 4 formulas are as follows:

$${y}_{t} = 5 t [ 0.2969 \sqrt{\frac{x}{c}} - 0.1260 ( \frac{x}{c} ) - 0.3516 {( \frac{x}{c} )}^{2} + 0.284 \; 3 {( \frac{x}{c} )}^{3} - 0.1015 {( \frac{x}{c} )}^{4} ]$$

$${y}_{c} = \{ \begin{matrix}\frac{m}{{p}^{2}} ( 2 p ( \frac{x}{c} ) - {( \frac{x}{c} )}^{2} ) , 0 \leq x \leq pc \\ \frac{m}{{( 1 - p )}^{2}} ( ( 1 - 2 p ) + 2 p ( \frac{x}{c} ) - {( \frac{x}{c} )}^{2} ) , pc \leq x \leq c\end{matrix} \}$$

$$\frac{d {y}_{c}}{d x} = \{ \begin{matrix}2 \frac{m}{{p}^{2}} ( p - ( \frac{x}{c} ) - {( \frac{x}{c} )}^{2} ) , 0 \leq x \leq pc \\ \frac{2 m}{{( 1 - p )}^{2}} ( p - ( \frac{x}{c} ) ) , pc \leq x \leq c\end{matrix} \}$$

$${X}_{U} = x - {y}_{t} sin θ$$

$${X}_{L} = x + {y}_{t} sin θ$$

$${Y}_{U} = {y}_{c} + {y}_{t} cos θ$$

$${Y}_{L} = {y}_{c} - {y}_{t} cos θ$$

$$θ = {tan}^{- 1} ( \frac{d {y}_{c}}{d x} )$$

After the airfoil shape is created, scale the shape by the desired length of the chord, and rotate the airfoil around the blade origin by the angle of alpha for that profile. Using these variables in a 4-digit NACA formula shown above, it is possible to create a profile of any camber, setback, thickness, chord scale or rotation around the origin of the profile axes.

It should be noted that, when using the NACA 4 system, care must be taken to ensure that the definitions and notations for the various parameters are consistent and that they are being used consistently. Care also must be taken in scaling from a chord of 1.0 to other chord values, particularly in view of the fact that other NACA 4 parameters are related to or depend on the chord. Techniques for ensuring that such scaling is accurate and reliable are known in the art and should be considered.

Although a NACA 4 profile can be used to designate the shape of an aerodynamic body—here the impeller blades—at a particular cross section of the blade, actual aerodynamic bodies such as airfoils and impeller blades have a length associated with them and thus have a three-dimensional quality that typically must be considered in practical engineering applications, as discussed herein above. The shape profile typically represents the shape of the blade, but only at the location along the length of the blade where the profile is taken. There are multiple locations—theoretically an infinite number—along the length of the blade. In some cases it is possible to mathematically describe the set of profiles throughout the full length of the blade. In many others, however, it suffices to use profile information at one or more points along the length and to interpolate, extrapolate, extend or otherwise approximate the full set of profiles from this. Similarly, in designing or constructing such blades, one may use one or a subset of profiles at selected locations along the blade length, and to curve or otherwise shape the blade down its length to conform the surface as desired, e.g., from a desired or selected base profile to a desired or selected tip profile.

In addition, although the NACA 4 parameters provide information to designate and construct the profile or profiles of an impeller blade, they do not designate or specify the angle or pitch of the blade, e.g., relative to the longitudinal axis or, correspondingly, relative to the rotational plane normal to the longitudinal axis. To address this, impeller blade angle or pitch is described herein using a reference angle theta (θ) and a blade tip angle alpha (α).

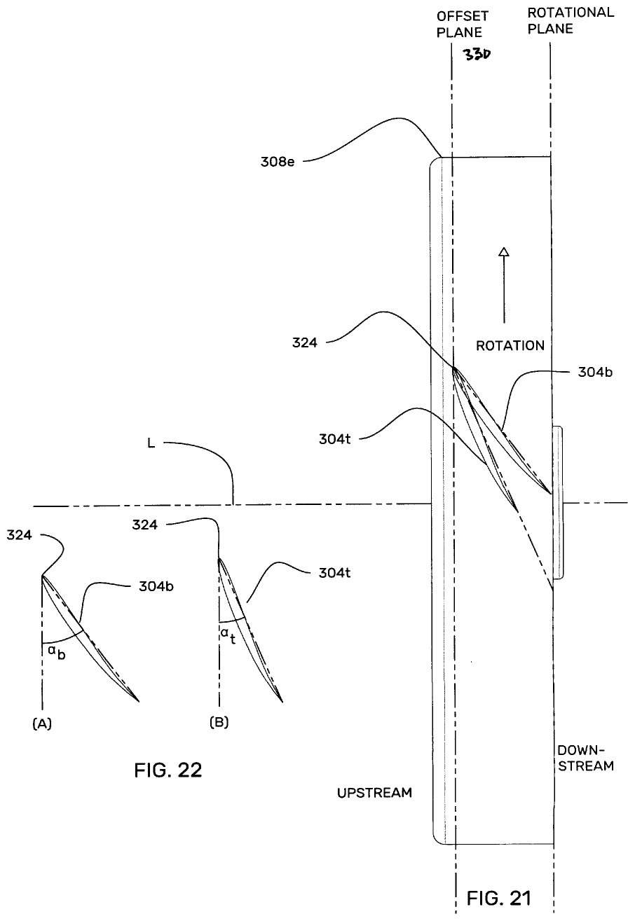

An example of this is illustrated in FIGS. 21 and 22. FIG. 21 is a view of hub 302 taken radially inward and longitudinally down a blade 304 attached to hub 302. Only a single blade is shown here, but merely for simplicity and ease of illustration. Hub 302 is disposed at its downstream side along a rotational plane that lies perpendicular to longitudinal axis L. An offset plane 330 parallel to the rotational plane but disposed at offset 310c is shown in the drawing figure. The leading edge 324 of each of the blades 304 is disposed at or immediately adjacent to the offset plane.

Given this perspective down the blade length, and recalling that, as illustrated in FIGS. 17-19, each blade 304 has a curvature along the blade length, each blade has a corresponding base profile 304b and tip profile 304t. As illustrated in FIGS. 18 and 19, the base profile 304b has a curvature that is relatively significantly greater than that of tip profile 304. This is shown in FIG. 21, in which blade 304 is shown as overlapping superposed profiles, one of which (shown in dashed outline) is a base profile 304b corresponding to the profile at arrows D-D in FIG. 17 and in FIG. 18, and the other of which (shown in solid lines) is blade tip profile 304t corresponding to the profile at arrows E-E of FIG. 17 and in FIG. 19. The chord lines of these respective profiles can be used as a measure of the angular position of the respective profiles, i.e., relative to the offset plane. These differing blade curvatures or angles are shown perhaps more clearly in FIG. 22, which shows profiles 304b and 304t side by side, rather than superposed on one another. FIG. 22(A) shows that base profile 304b makes an angle α_{b} with respect to the offset plane, and FIG. 22(B) shows that tip profile 304t makes an angle αₜ with respect to that plane. Thus, to more fully characterize an impeller blade, in addition to one or more profiles described using their respective NACA 4 parameters, those profiles may further be characterized using their profile blade angles, e.g., alpha and theta as described herein.

In many cases there is a uniform angular offset of the blade angle, e.g., relative to the offset plane 330, that applies to all of the blades uniformly and, in addition, each blade has an additional angle in its profiles down the length of the blade. In such cases, for analytical or descriptive purposes it is useful to treat these two angular components as separate variables when describing an impeller blade. The first component, which represents a common or reference angular offset, is referred to herein as an “reference blade angle” and is designated herein by the Greek letter theta (θ). The second component, which typically reflects the angular variation of the profiles down the length of a given blade relative to the reference blade angle θ, is designed herein by the Greek letter alpha (α).

To quantitatively describe impellers according to this aspect of the invention, it is useful to provide a reference frame in which to characterize the various components and relate them to one another. Given the relatively complex geometric relationships between the components, a simple reference system such as a single rectilinear coordinate systems will not always suffice. If a rectilinear coordinate system is overlain on the impeller hub, for example, the characterizations of blade angles down the length of each impeller blade can become relatively complex. To illustrate, consider the following.

Theoretically, one could merely set a reference plane based on the blade profiles. One example would be to use hub offset plane 330 as a reference plane. In some embodiments, the leading edge of each impeller is located at or immediately adjacent to this plane. Angles or rotations of the respective blades, either as a reference angle θ or as a blade tip angle α, then can be expressed as, for example, the angle the chord line of the blade makes with this reference plane. As shown in FIG. 22, for example, the base profile angle α_{b} for the base profile 304b then could be specified for this profile, as indicated at the left of the drawing figure at (A). Similarly, the blade tip profile angle αₜ for the blade tip profile 304t then could be specified for this profile, as indicated at the right of the drawing figure at (B). Reference angle θ could be incorporated as a constant angular offset for all blade profiles and for all blades, e.g., so that the blade tip angle relative to the rotational plane of the impeller would in effect be the sum of the reference angle θ and the blade profile angle αi, where θ is the constant or reference angle for all blades relative to the reference plane (generally the rotational plane) and αi represents the angle at each blade for the i^{th} profile.

To better illustrate aspects of the invention and related embodiments, a reference frame or reference system for use herein will now be described. In summary, the reference frame or system can be outlined as follows:

1. Establish a rectilinear set of three mutually orthogonal planes for the impeller as a whole;

2. Establish a separate or different rectilinear coordinate system for the blades, individually and collectively;

3. Define or set a reference angle θ that is used as a single representative or reference rotation for the blades and blade profiles, and which ties or correlates the impeller reference frame to the blade reference frame; and

4. Characterize each impeller blade and the blades collectively in terms of the reference angle θ and a specific blade angle α that specifies the specific angle for each shape profile of the blade.

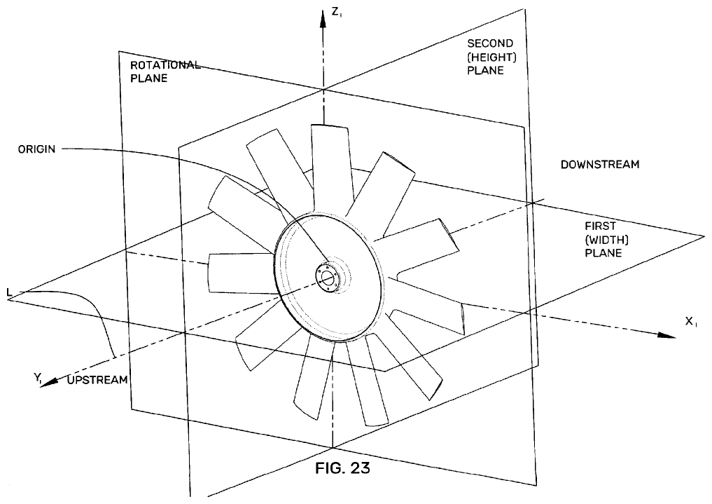

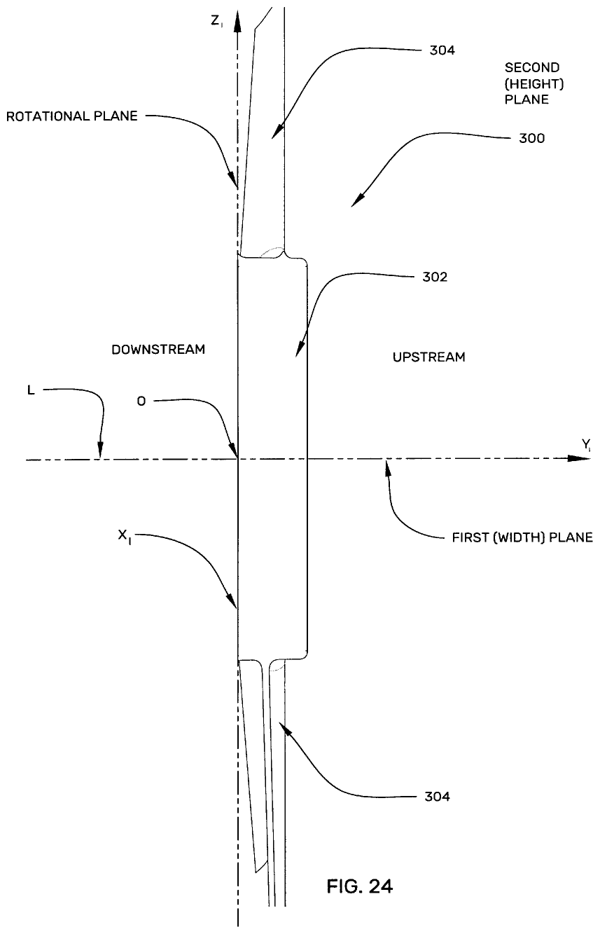

In establishing a rectilinear system for the impeller as a whole, three mutually-orthogonal planes are defined. FIG. 23 provides a perspective view of an impeller, such as impeller 300, and FIG. 24 provides a side view viewed as if the viewer were viewing from the left side of FIG. 23 at the plane of the drawing sheet and thus looking at the impeller along the line of rotational plane. The impellers that would be located on the hub as viewed in FIG. 24 have been omitted for simplicity and better illustration. Longitudinal axis L extends down the center of the impeller through the center of the hub axle.

A “rotational plane” lies at the downstream end of the hub, perpendicular to the longitudinal axis L and parallel to the hub body. In FIG. 23, this rotational plane would be essentially parallel to the plane of the drawing sheet. In FIG. 24, it lies vertically along the drawing sheet and perpendicular to it. The rotational plane represents the plane in which the impeller rotates.

A “first” or “width” plane lies along the longitudinal axis L perpendicular to the rotational plane along a first or arbitrarily-selected width dimension. In FIG. 23, the first or width plane lies essentially horizontally from the perspective of the drawing sheet, in effect projecting horizontally into and out of the drawing sheet. In FIG. 24, the first or width plane is positioned at and along the longitudinal axis and would extend horizontally into and out of the plane of the drawing sheet.

A “second” or “height” plane lies along the longitudinal axis L perpendicular to the rotational plane and the first or width plane. In FIG. 23, the second or height plane lies essentially vertically from the perspective of the drawing, in effect projecting vertically into and out of the drawing sheet. In FIG. 24, the second or height plane is positioned at and along the longitudinal axis and would lie in the plane of the drawing sheet.

A second rectilinear coordinate system, this one for the impeller blades, comprises an x axis xi that extends perpendicularly to the longitudinal axis and along the intersection of the rotational plane and the first or width plane. It also comprises a y axis y_{I} that extends along and is identical with the longitudinal axis L of the impeller. This coordinate system further comprises a z axis z_{I} runs through the origin O and extends perpendicularly with respect to the x and y axes xi and y_{I}, respectively. The z axis in this reference system is colinear with, and thus the same as, longitudinal axis L.

To construct this second rectilinear coordinate system for the impeller blades, a characteristic or reference blade angle θ is selected or defined. This reference blade angle θ serves as a fixed or reference angle that is standardized for common use in defining the angular position of each of the blades and each of the corresponding blade shape profiles. As one sets or calculates the specific blade angles for the various shape profiles at various lengths down the various blades, the blade angle may and often does vary. This reference angle θ provides a fixed or standardized angle with respect to all of the blades and for all blade angle profiles. Once it is established, relative blade angles can be selected or set for further designation of total blade angle. In light of this, reference blade angle θ may be selected or set arbitrarily, but preferably is set to be reflective of a common angle characteristic of all blades, or of a meaningful characteristic of the individual blades. An example of the former would be, for example, selecting the reference blade angle θ to be representative of the common blade angle for all blades at a given length position on the respective blades, e.g., the blade angle for each blade at the base profile, or at the blade tip.

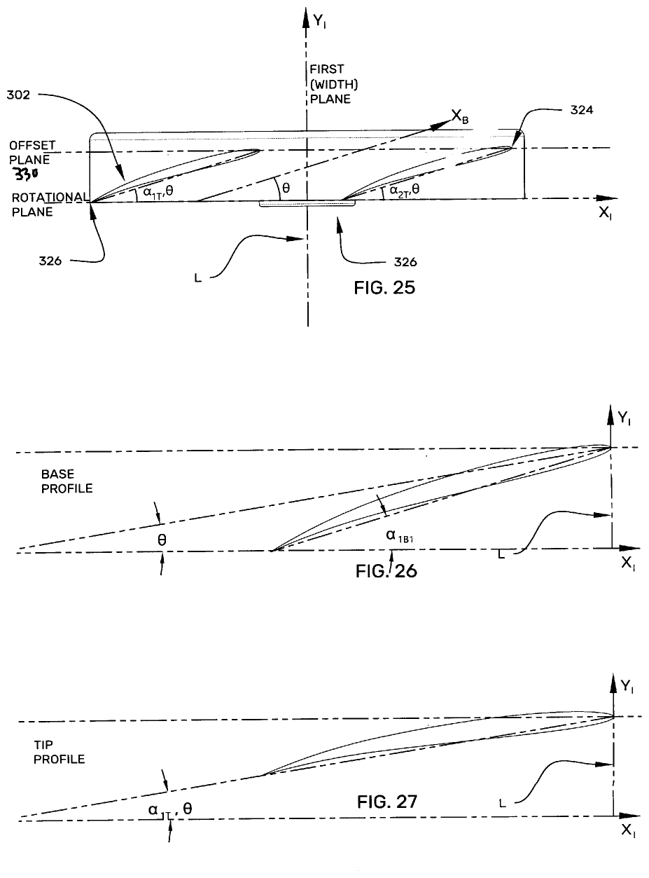

This can be illustrated with reference to FIGS. 25-27. FIG. 25 shows a top view looking down on a portion of hub 302 and more specifically hub flat 310. For simplicity, only two blades 304-1 and 304-2 are shown, and the spacing between them is exaggerated. For both blades, the leading edge 324 lies at the line x_{B} of the offset plane 330. Both of the blades in FIG. 25 are shown at the base profiles, i.e., adjacent to where the blade meets the hub flat 310. The blades at these profiles, and more specifically the chord lines for the blades, form the same angle α_{b} with respect to the offset plane and the rotational plane, where the “b” indicates the base profile. For blade 304-1 this base profile blade angle is identified as α_{1b} and for blade 304-2 it is identified as α_{2b}. In this illustrative example, the reference blade angle θ also is set at this angle, as indicated in the center of the hub in FIG. 25.

FIGS. 26 and 27 show a comparison between the blade angles for the base profile and the tip profile for each of the blades 304-1 and 304-2. FIG. 26 shows the base profile for one of the blades 304-1 of FIG. 25, and FIG. 27 shows the tip profile for the same blade 304-1, recognizing of course that this blade is merely representative of the other blades in this embodiment and is shown isolated here from the other blades for simplicity and ease of illustration. As shown, for example, in FIGS. 18-19, the tip profile has a flatter angle or pitch with respect to the offset plane or rotational place that the base profile. Accordingly, the tip profile blade angle α_{1T} of blade 304-1 (i.e., angle α of blade 1 at the tip (T) profile) (FIG. 27) is smaller than the base profile blade angle α_{1B} of blade 304-1 (i.e., angle α of blade 1 at the base (B) profile). The reference blade angle θ, which remains constant once set and is the same for all blades on the given impeller and all profiles of a given one of the impeller blades, is shown in FIG. 27. The change in blade angle α down the length of the blade 304-1 relative to reference blade angle θ thus is:

Blade angle change=Base profile blade angle α_{1B}−tip profile blade angle α_{1T} down length of blade

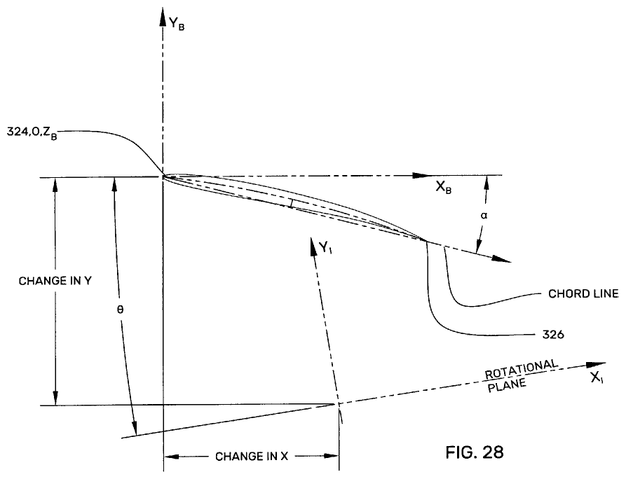

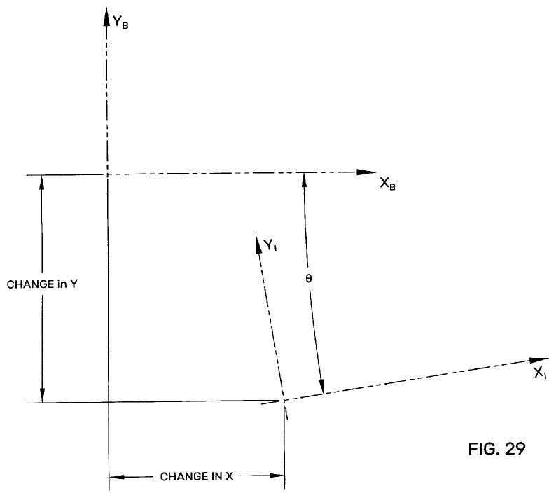

The spatial relationships between the blade (as measured by its chord line), the rotational plane, the reference blade angle θ, the blade profile angle α, and the blade shape profile parameters is illustrated in FIG. 28. Once the reference blade angle θ is set or established, this allows one to set the x axis x_{B} of a three-axis (x,y,z) rectilinear coordinate system for the respective blades. (See also FIGS. 17-19.) The origin O of this rectilinear coordinate system is located at the leading edge 324 of the blade profile. The x_{B} axis extends generally along the chord line of the blade, but with an angular offset. The z_{B} axis runs along the leading edge of the blade, which in this illustrative blade embodiment is linear. The y_{B} axis is mutually orthogonal with respect to the x_{B} axis and the z_{B} axis. It generally runs orthogonally with respect to the chord line, but again, with an angular offset. These rectilinear axes and this rectilinear blade reference frame apply to all blade shape profiles for a given blade and for all blades of a given impeller.

In view of this blade-centric reference frame, the specification of a blade and the profiles down the length of the blade can be characterized or described using the four NACA 4 parameters, (i.e., MPXX), the reference blade angle θ, the blade length, and the blade profile angles α at locations along the length of the blade. It allows one to graphically specify an impeller configuration, including blade profile and rotational positions relative to the hub, for a given set of parameters. If preferred, one may add hub sizing and blade length to the four NACA 4 parameters, the reference blade angle θ and the blade profile angle α along the length of the blade to gain a fuller set of characterizing impeller parameters. If the blade profiles are uniform down the length of the blade, these parameters serve as a relatively full set to characterize the impeller. If the blade profiles vary down the length of the impeller blades, one may generate multiple parameters sets, each having the format shown in FIG. 28.

By placing multiple profiles on parallel planes at differing distances from each other, a series of profiles can be created. Lofting between these profiles creates a blade or wing. While any number of profiles can be used to define a blade, with a minimum of one and no theoretical maximum, the blades of impeller 300 were designed using only two: one base profile and one tip profile.

When using a single mold design, where the hub and blades are one integrated piece, profile axes change in x_{B}, change in y_{B} and theta will dictate the blade position. However, when using a modular design, the blade angle in respect to the hub may be rotated around an axis that does not go through the hub origin or profile origin. These types of blades can be adjusted to increase or decrease flow either while stopped in some models or during operation in others.

It will be noted and appreciated that, depending on the spacing between blade profiles along the blade length that one wishes to consider, there may be as few as one (for a uniform shape profile down the entire length of the blade), and at least theoretically there is an infinite number of infinitely thin profiles. In practice, as a simplifying measure, one may take a relatively small number of profiles at points along the length of the blades, and simply make a smooth surface transition from one to another. This provides a relatively robust range of profiles between the selected profiles with relatively modest calculation, and yet can provide a reasonably accurate and predictable characterization of the blades. In presently-preferred embodiments according to this aspect of the invention, for example, as noted herein above, one may select a base profile and a tip profile as has been described herein, and from these two profiles simply make a smooth surface transition on the blade surfaces from one to the other.

In presently-preferred methods and in the design of certain presently-preferred embodiments, including impeller 300, each of the impeller blades is shaped by selecting a first cross sectional profile at or near the base of the blade, selecting a second cross sectional profile at or near the tip of the blade, and interpolating a blade shape that smoothly transitions between and from these two defining blade profiles. Using this approach, all of the blades of the impeller are substantially identical and are configured in the same way. The first cross sectional profile preferably is located between about 30 percent and 45 percent of the blade length from the proximal or base end. The second cross sectional profile preferably is located between about 90 and 120 percent of the blade length. Having a profile that is beyond the length of the blade itself may seem counter-intuitive, but using this approach one may obtain a blade shape evolution that, although ultimately partially truncated, provides the optimal overall flow inducement characteristics.

The NACA 4 parameters are defined in terms of the chord length (C) or simply “chord,” which can vary from application to application and design to design. In presently-preferred embodiment impeller 300, the chord is 5.5 inches.

In presently-preferred impeller embodiments, and starting at the profile at the proximal or base end, the first maximum camber (m1) preferably is between about 0.02 and 0.05 times the first chord length (C1), the first maximum camber position (P1) preferably is between about 0.5 and 0.75 times the first chord length (C1), and the first thickness (t1) preferably is between about 0.04 and 0.07 times the first chord length (C1).

For the profile at the distal or blade tip end, chord or second chord length (C2) is 5 inches. In this “second” or tip end profile, the second maximum camber (m2) preferably is between about 0.02 and 0.05 times the second chord length (C2), the second maximum camber position (P2) preferably is between about 0.5 and 0.75 times the second chord length (C2), and the second thickness (t2) preferably is between about 0.04 and 0.07 times the second chord length (C2).

In some presently-preferred impellers the chord length of the first and second profiles are the same but in others, and in impeller 300, they differ from one another.

In the presently-preferred but merely illustrative embodiment of impeller 300, the preferred parameters for the proximal or base profile include NACA 4 numbers m=3.5, p=65, t=06, and c=5.5. This base blade profile is on a plane that is 8.56 inches from the front plane. The blade tip angle is 13 degrees after trim.

As to the distal or blade tip profile, the NACA 4 parameters are m=2.5, p=65, t=5.5, and c=5.0. This blade tip profile is on a plane that is 23.56 inches from the front plane. The change in x is 3 inches, the change in y is 1.5 inches.

In a presently-preferred method for making the impeller, the mold is a traditional negative two part with open center. The mold is made so that it has a lip flange around the outside rim for placement of a gasket in order to lower the air pressure on the interior of the mold. The center hub of the mold is created by a silicon shaft that enters and exits longitudinally from the mold. The surface of the mold is covered with resin-soaked fiberglass. Then the center of the mold is filled with additional fiberglass matting before the injection of the fill resin. Once the matting is lain in, the mold upper part is placed into the lower part of the mold and the silicon center hub is installed to allow the mold to be sealed. The pressure in the mold is then lowered as the resin is injected to precipitate the complete penetration of resin into the dry fiberglass, filling the mold center. After curing, the impeller may be removed and machined for use. It is then covered or encased on its exterior surface with a hard gelcoat.

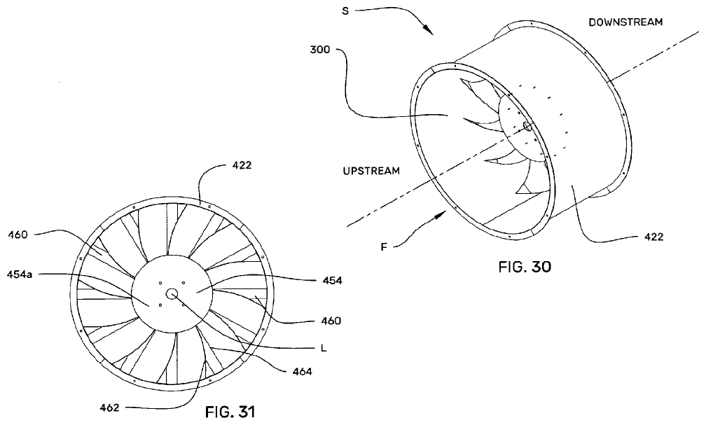

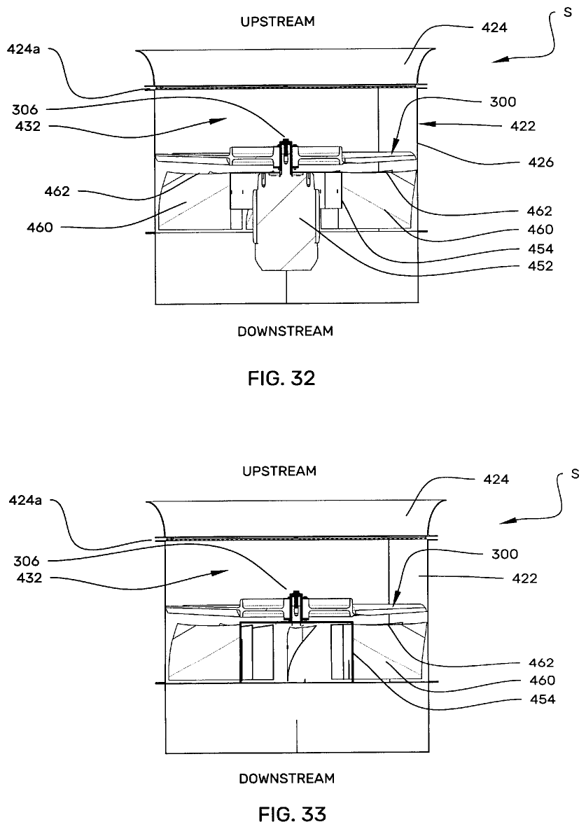

Impellers according to this aspect of the invention, e.g., such as impeller 300, may be embodied in or used in connection with an impeller system. To illustrate, a system S according to a presently-preferred embodiment of this system-related aspect of the invention will now be described. FIG. 30 shows a perspective of system S, FIG. 31 provides a longitudinal view but with the impeller blades omitted to better illustrate the underlying guide vanes, and FIG. 32 provides a side cutaway view. FIG. 33 provides a side cutaway view that illustrates the positioning of and interaction between the impeller and guide vanes for this embodiment.

System S comprises an impeller according to impeller-related aspects of the invention as described herein and illustrated in the drawing figures. For simplicity and ease of illustration, system S as presented herein comprises impeller 300 as described and illustrated herein. Impeller 300, which is disposed about longitudinal axis L, comprises hub 302 and blades 304.

System S includes a housing 422 essentially identical to housing 122 of evaporator 120 and housing 222 of evaporator 220. Housing 422 comprises an inlet bell 424, and a substantially-cylindrical fan case assembly 426 that includes fan casing 426a. The interior of housing 422, longitudinally through air inlet bell 424 and fan casing 426a comprises an air flow channel 432. Impeller 300 is disposed approximately half way down the interior of the fan casing 426a longitudinally and is radially centered about longitudinal axis L.

The flow characteristics with air flow channel 432 often can be improved to increase evaporation efficiency by the inclusion of an air gap, e.g., such as air gap 124a as described herein above. Accordingly, in system S an air gap 424a is provided between inlet bell 424 and fan casing 426a, as described herein above for air gap 124a. In this embodiment as in evaporator 120, the air gap preferably is ½ inch wide in the longitudinal direction.

System S further comprises a mechanical drive means as described herein above for rotating impeller 300. The drive means of system S comprises an electrical AC induction motor 452, the output shaft of which is directly coupled to hub axle 306 of impeller 300 to drive the impeller in a counterclockwise direction, e.g., as indicated in FIG. 9. Motor 452 and impeller 300 are physically supported within fan case assembly 426 by a C-face mount 454. C-face mount 454 includes a top surface 454a (e.g., FIG. 31), that lies orthogonally with respect to longitudinal axis L and lies in a plane parallel to the rotational plane. Although impeller 300 has been omitted from FIG. 31 for simplicity and ease of illustration, particularly with regard to the guide vanes (described below), when fully assembled to include impeller 300, hub 302 is rotably disposed immediately above top surface 454a of C-face mount 454.

System S further comprises a plurality of guide vanes 460 fixedly disposed in the interior of the fan case assembly 426 and in the air flow channel 432. In this illustrative embodiment there are eleven identical guide vanes uniformly spaced apart from one another. Each guide vane 460 includes a radially-proximal edge 462 and a radially-distal edge 464. Proximal edge 462 is fixedly attached to the outer wall of C-face mount 454, and distal edge 464 is fixedly attached to the interior wall of fan casing 426a. Impeller 300 when system S is fully assembled and operated normally is disposed immediately upstream with respect to guide vanes 460 and directs air flow downstream onto those guide vanes. Accordingly, for each guide vane 460, proximal edge 462 comprises a leading edge at its upstream end that engages and directs the air flow, and distal edge 464 comprises a trailing edge at the downstream end of the guide vane.

Considering the impeller in isolation for a moment, as the impeller rotates during normal operation, the air flow stream downstream of the impeller will have not only a longitudinal downstream velocity or flow component, but also a torsional flow component within the housing. This torsional flow promotes turbulence in the air flow, generally increases flow resistance, and generally reduces flow efficiency.

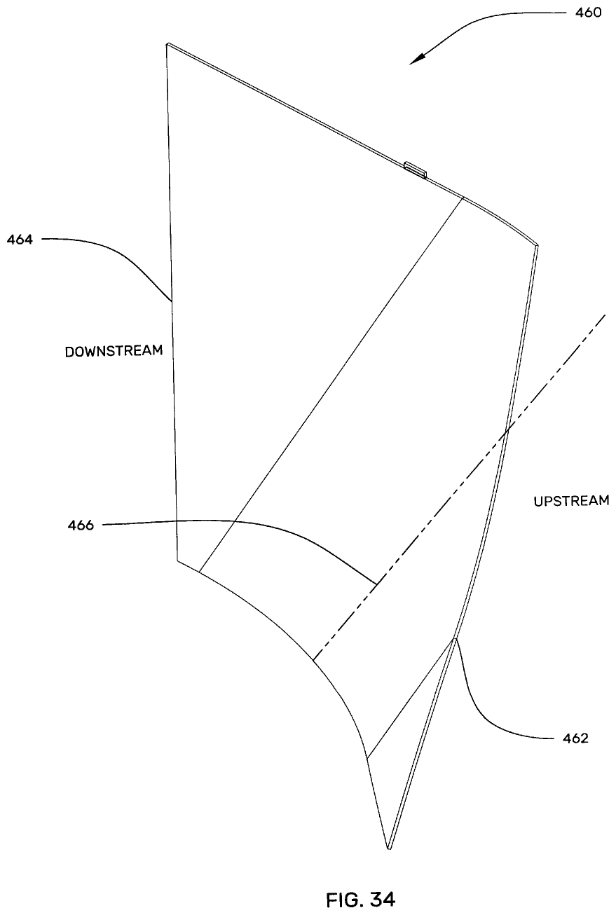

Accordingly, at least in part to address this radial flow concern, each guide vane includes an angle or curvature that receives the air flow off of the impeller and converts the radial flow into a more longitudinal flow. The guide vane surfaces may simply comprise a planar or substantially-planar surface that is angled, for example, with respect to the first and second planes of FIG. 23. More preferably, however, it comprises a curved three-dimensional surface extending in the downstream direction. The curvature of the surface ideally is such that it matches the radial flow direction at the leading edge 462 of each guide vane 460, and the curvature along the surface in the longitudinal direction smoothly transitions the air flow to a completely longitudinal flow. Meeting this ideal condition, however, often is difficult or even impracticable given such limitations as, for example, the air flow conditions such as velocity, the limited distance within the fan casing 426a in the longitudinal direction, weight constraints, cost constraints, complexity and cost of manufacture, etc. Accordingly, one preferably constructs the guide vanes to have a shape that approximates these ideal circumstances but compromises these ideal design features, for example, in the following ways. An illustrative example is provided in FIG. 34. The curvature of the guide vane surface is greatest at the leading edge 462, albeit less than the angle of radial flow off the impeller. The curvature decreases longitudinally down the surface in the downstream direction, and the last 10% to 20% of the surface at the downstream end, e.g., as indicated by line 466, is parallel to the longitudinal axis.

The spacing between the downstream end of the impeller blades and the leading edge of the guide vanes ideally under most circumstances is as narrow as is practicable. In the absence of guide vanes, the air flow that emerges from the downstream side of the impeller, and more specifically the radial component of that air flow, will have several effects. One is that it will collide with other portions of the air in the air flow channel and will impede what otherwise would be developed flow down the air flow channel. Another is that the radial flow itself will facilitate turbulence in the air flow channel. The sooner this initial air flow off the impeller is channeled or directed into the longitudinal direction, the less opportunity there will be for these deleterious effects to develop.

Accordingly, by positioning the guide vanes immediately downstream of the impeller blades, and by spacing the downstream end of the impeller blades and the leading edge of the guide vanes as closely together as the design and circumstances permit, the operational efficiency of the system and any evaporator in which it is used will be enhanced.

Taking advantage of this insight, in presently-preferred system embodiment S, guide vanes 460 are positioned within air flow channel 432 so that the downstream end of impeller blades 304 are as close as is practicable, for example, one quarter to one half of an inch downstream relative to offset plane 330. Note that, for example, with reference to FIG. 24, the blades 304 of impeller 300 have a slight upstream orientation down the length of each blade. For impeller blades that instead have a planar downstream edge profile, and especially where the planes are orthogonal with respect to the longitudinal axis L and parallel to the rotational place, one may use guide vanes having a similarly planar leading edge profile, in which case the longitudinal spacing between the downstream edge of the impeller blades and the upstream edge of the guide vanes can have be uniform. In circumstances in which the downstream edge of the impeller blades is not planar, e.g., as shown in FIG. 24, the spacing is less simple. One approach in this instance would be to make the leading edges of the respective guide vanes to have angular positioning, so that they are parallel to the downstream end of the impeller blades and can have uniform spacing. Another approach is to approximate the spacing, e.g., as has been done here, by using a linear guide vane leading edge and measuring the spacing with respect to the rotational plane at the downstream end of hub flat 310, which is approximately parallel to the downstream edge of the impeller blades. In this particular impeller embodiment, this in effect is the same as using the downstream edge of the impeller blade at the intersection of the blade and the hub flat 310 (the furthest downstream location of the blade down its length) as a proxy for the downstream impeller blade edge location for the entire blade length. Another approach would be to use the average position of the downstream impeller blade, or the median position, as a proxy for the downstream impeller blade edge location.

In some presently-preferred embodiments, for example, such as those where fiberglass or other relatively light materials are used, the impellers can be operated at considerably lower rotational speeds relative to comparable conventional impellers. In impeller 300, for example, one may advantageously operate it at about 1,200 RPM, as opposed to prior or conventional impellers of similar size or air flow capacity which often operated at rotational speeds of about 2,800 to 3,600 RPM. Many presently-preferred embodiments also require substantially less torque and power, and require substantially smaller, cheaper and more widely-available power sources, such as lower horsepower motors that can operate with substantially lower voltage or wattage power systems. In many instances, this means that evaporators that incorporate these features of the invention can be made significantly more widely and in locations, applications and circumstances that previously could not be serviced because of limitations in the availability of such resources.

Additional advantages and modifications will readily occur to those skilled in the art. Therefore, the invention in its broader aspects is not limited to the specific details, representative devices and methods, and illustrative examples shown and described. Accordingly, departures may be made from such details without departing from the spirit or scope of the general inventive concept as defined by the appended claims and their equivalents.

1. An impeller for inducing flow of air from an upstream side to a downstream side to evaporate water at a water body, the impeller comprising:
a hub lying along a plane of rotation and comprising a hub perimeter; and
a plurality of blades fixedly coupled to the hub, spaced about the hub perimeter and having a blade length dimension,
each of the blades having a cross sectional profile in an impeller blade length plane perpendicular to the blade length dimension,
the cross-sectional profile comprising a chord line and a NACA 4 profile having parameters chord length (c), maximum camber (m), maximum camber position (p), and thickness (t),
the maximum camber (m) being between about 0.02 and 0.045 times the chord length (c),
the maximum camber position (p) being between about 0.5 and 0.75 times the chord length (c), and
the thickness (t) being between about 0.04 and 0.07 times the chord length.

2. An impeller for inducing flow of air from an upstream side to a downstream side to evaporate water at a water body, the impeller comprising:
a hub lying along a plane of rotation and comprising a hub perimeter; and
a plurality of blades fixedly coupled to the hub, spaced about the hub perimeter and having a blade length dimension;
the plurality of blades comprising a first impeller blade length plane proximate to the hub and a second impeller blade length plane spaced at a distal location relative to the hub along the blade length dimension;
the blade having a first cross sectional profile in the first impeller blade length plane perpendicular to the blade length dimension and a second cross sectional profile in the second impeller blade length plane perpendicular to the blade length dimension at the distal location;
each of the first and second cross sectional profiles comprising a chord line and a NACA 4 profile having parameters chord length (c), maximum camber (m), maximum camber position (p), and thickness (t);
the first cross sectional profile having the maximum camber (m) between about 0.02 and 0.05 times the chord length (c),
the maximum camber position (p) between about 0.5 and 0.75 times the chord length (c), and the thickness (t) between about 0.04 and 0.07 times the chord length (c); and
the second cross sectional profile having the maximum camber (m) between about 0.02 and 0.05 times the chord length (c),
the maximum camber position (p) between about 0.5 and 0.75 times the chord length (c), and the thickness (t) between about 0.04 and 0.07 times the chord length (c).

3. An impeller as recited in claim 2, wherein:
each of the blades comprises a blade length along the blade length dimension; and
the first impeller blade length plane is disposed no more than 30 percent of the blade length from the hub perimeter.

4. An impeller as recited in claim 2, wherein:
each of the blades comprises a blade length along the blade length dimension;
the second impeller blade length plane is disposed at least 90 percent of the blade length from the hub perimeter.

5. An impeller as recited in claim 2, wherein:
each of the blades comprises a blade length along the blade length dimension;
the first impeller blade length plane is disposed nor more than 45 percent of the blade length from the hub perimeter; and
the second impeller blade length plane is disposed at least 120 percent of the blade length from the hub perimeter.

6. An impeller as recited in claim 1, 2, 3, 4 or 5, wherein the hub and the blades consist essentially of a single integrated body.

7. An impeller as recited in claim 1, 2, 3, 4 or 5, wherein:
the hub and the blades consist essentially of a single material.

8. An impeller as recited in claim 1, 2, 3, 4 or 5, wherein:
the hub and the blades consist essentially of at least one of a polymeric material and a resin-based material.

9. An impeller as recited in claim 1, 2, 3, 4 or 5, wherein:
the hub and the blades consist essentially of at least one of a coated polymeric material, and a coated resin-based material, and a coated fiberglass.

10. An impeller as recited in claim 1, 2, 3, 4 or 5, wherein the blades are detachable from the hub.

11. An impeller as recited in claim 1, 2, 3, 4 or 5 wherein:
the impeller and the hub comprise an upstream side and a downstream side, and the upstream side of the hub comprises an upstream hub side area;
the upstream side of the hub comprises a concave region that comprises substantially all of the upstream hub side area.

12. An impeller as recited in claim 1, 2, 3, 4 or 5 wherein:
the impeller and the hub comprise an upstream side and a downstream side, and the upstream side of the hub comprises an upstream hub side area;
the upstream side of the hub comprises a concave region that comprises at least 90% of the upstream hub side area.

13. An impeller as recited in claim 1, 2, 3, 4 or 5 wherein:
the impeller and the hub comprise an upstream side and a downstream side, and the upstream side of the hub comprises an upstream hub side area;
the upstream side of the hub comprises a concave region that is free of a structural obstruction that interferes with direct contact of the air at the upstream side of the hub.

14. An impeller as recited in claim 1, 2, 3, 4 or 5, wherein:
the hub comprises a perimeter wall at the upstream side of the hub;
the perimeter wall comprises an outer corner; and
the outer corner comprises a non-perpendicular edge.

15. An impeller as recited in claim 1, 2, 3, 4 or 5, wherein:
the hub comprises a perimeter wall at the upstream side of the hub;
the perimeter wall comprises an outer corner; and
the outer corner comprises a non-perpendicular edge, wherein the non-perpendicular edge comprises at least one of a bevel, a taper, a rounded corner, and a bull nose edge.

16. An impeller as recited in claim 1, 2, 3, 4 or 5, wherein:
the hub comprises a perimeter wall at the upstream side of the hub;
the perimeter wall comprises an outer corner; and
the outer corner comprises a non-perpendicular edge, wherein the non-perpendicular edge comprises a rounded corner comprising a radial curvature of between about ¼ inch and about ½ inch.

17. An impeller as recited in claim 1, 2, 3, 4 or 5, wherein:
the hub comprises a substantially planar upstream profile substantially perpendicular to a longitudinal axis of the impeller;
the blades comprise a substantially planar upstream profile substantially perpendicular to the longitudinal axis of the impeller; and
the upstream profile of the blades is offset toward the downstream side relative to the upstream profile of the hub.

18. An impeller as recited in claim 1, 2, 3, 4 or 5, wherein:
the hub comprises a substantially planar upstream profile substantially perpendicular to a longitudinal axis of the impeller;
the blades comprise a substantially planar upstream profile substantially perpendicular to the longitudinal axis of the impeller; and
the upstream profile of the blades is offset toward the downstream side relative to the upstream profile of the hub, wherein the hub at an operational speed generates a center spin of the air at the upstream side of the hub and at the upstream profile of the hub and the offset is disposed at a distance downstream of the upstream profile of the hub sufficient to avoid the center spin of the air.

19. An impeller as recited in claim 1, 2, 3, 4 or 5, wherein the impeller comprises between eight and twelve of the blades.

20. An impeller as recited in claim 1, 2, 3, 4 or 5, wherein the impeller comprises eleven of the blades.

21. An impeller as recited in claim 1, 2, 3, 4 or 5, wherein the impeller comprises eighteen of the blades.

22. A system for evaporating water from an ambient water body, the system comprising:
a casing having an upstream end, a downstream end, and a casing flow channel;
an impeller as recited in claim 1, 2, 3, 4 or 5, disposed within the casing and in fluid communication with the casing flow channel to move air in a downstream direction from the upstream end toward the downstream end of the casing flow channel; and
a plurality of guide vanes disposed in the downstream direction relative to the impeller.

23. A system as recited in claim 22, wherein the guide vanes are disposed immediately downstream with respect to the impeller.

24. A system as recited in claim 22 or 23, wherein the guide vanes comprise a curved profile.

25. A system as recited in claim 22, 23 or 24, wherein the guide vanes are curved sufficiently that the guide vanes straighten air flow with respect to the longitudinal axis and lessen air flow within the housing flow channel that is not parallel to the longitudinal axis.
